(19) United States
(12) Patent Application Publication
(10) Pub. No.: US 2011/0021335 A1
(43) Pub. Date: Jan. 27, 2011

(54) SOL-GEL PROCESS WITH A PROTECTED CATALYST

(76) Inventors: Pascal Jozef Paul Buskens, Heerlen (NL); Jens Christoph Thies, Eijsden (DE); Nanning Joerg Arfsten, Aachen (DE)

Correspondence Address: NIXON & VANDERHYE, PC, 901 NORTH GLEBE ROAD, 11TH FLOOR, ARLINGTON, VA, 22203, US

(21) Appl. No.: 12/747,975

(22) PCT Filed: Dec. 15, 2008
(86) PCT No.: PCT/EP08/67567

§ 371 Date: Sep. 20, 2010

(30) Foreign Application Priority Data
Dec. 14, 2007 (EP) 07024273.0

(51) Int. Cl. C04B 35/00; C09D 1/00; B05D 3/02

(52) U.S. Cl. 501/1; 106/286.1; 106/286.6; 106/286.4; 106/286.5; 106/286.7; 427/372.2

(57) ABSTRACT

The invention provides a sol-gel process for preparing a mixture of metal-oxide-metal compounds wherein at least one metal oxide precursor is subjected to a hydrolysis treatment to obtain one or more corresponding metal oxide hydroxides, the metal oxide hydroxides so obtained are subjected to a condensation treatment to form the metal-oxide-metal compounds, which process is carried out in the presence of a catalyst which comprises a labile protecting group (P9) and a base (B) which are covalently linked, whereby the covalent link between the protecting group and the base is cleavable by exposure to an external stimulus, and wherein the base released after exposure to such external stimulus is capable of catalyzing the condensation of the metal-hydroxide groups that are present in the metal oxide hydroxides so obtained.

The present invention relates to a sol-gel process for preparing a mixture of metal-oxide-metal compounds, a process for coating a substrate or article with said mixture, a substrate or article obtainable by said process, a process for preparing a ceramic object with said mixture and a substrate or article obtainable by said process.

Sol-gel chemistry involves a wet-chemical technique for the preparation of metal-oxide-metal compounds starting from a chemical solution which typically contains a precursor such as a metal alkoxide or a metal chloride. The precursor is usually subjected to a hydrolysis treatment and a condensation treatment to form metal-oxo or metal-hydroxo polymers in solution. The mechanism of both the hydrolysis and the condensation step are to a large extent dependent on the degree of acidity of the chemical solution.

In the case of the synthesis of polysiloxane coatings or ceramics, use can, for instance, be made of tetraalkoxysilanes as precursor materials. The sol-gel reaction can then in principle be divided into two steps:
(a) the (partial) hydrolysis of the tetraalkoxysilane monomers (1) (see Scheme 1), and
(b) the condensation of alkoxysilanes and silanols (2) to polysiloxanes (3) (see Scheme 2).

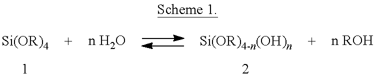

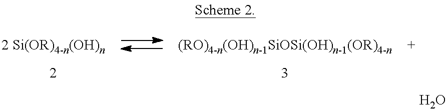

The sol-gel formulation so obtained can be used for many purposes including for instance to prepare ceramic objects or be deposited on a substrate using for example the dip coating technique. However, both the ceramic objects and the sol-gel coatings so obtained generally show an insufficient mechanical strength after drying under ambient conditions. One way to strengthen the inorganic network of the sol-gel ceramic or coating is to increase the degree of coupling in the inorganic network. For that purpose, a thermal post-condensation (curing step) is usually carried out. In case of sol-gel coatings, such a curing treatment is typically carried out at a temperature in the range of from 400 to 600° C. During the curing step further condensation is established which enhances the mechanical properties of the sol-gel coating to be obtained. In the case of ceramic objects, the post-condensation takes place during sintering at temperatures between 400° C. and 1500° C.

One disadvantage of the known sol-gel processes is that the use of a curing step, which is carried out at such an elevated temperature, restricts the range of possible applications. In this respect it is observed that most organic materials implemented in sol-gel coatings such as hydrophobising agents, typically fluoroalkyl compounds, or dyes are unstable and will decompose at high temperatures. In addition, most polymeric materials have a glass transition temperature and/or melting point below 400° C., which makes it very difficult to coat polymeric substrates or articles with a mechanically stable sol-gel film. A further disadvantage is that curing or sintering at high temperatures consumes a large amount of energy, may require special types of equipment, and can slow down a production process.

Bases, e.g. organic amines, are known to catalyze the post-condensation step of a sol-gel process and thereby allow a reduction of the curing temperature. See, for example Y. Liu, H. Chen, L. Zhang, X. Yao, Journal of Sol-Gel Science and Technology 2002, 25, 95-101 or I. Tilgner, P. Fischer, F. M. Bohnen, H. Rehage, W. F. Maier, Microporous Materials 1995, 5, 77-90]. These bases are commonly added to the sol-gel formulation causing a change in the degree of acidity of the formulation. Since the stability of a sol-gel formulation is determined by the ratio of hydrolysis and condensation and both of these processes are strongly dependent on the degree of acidity, addition of bases typically causes a destabilization of the formulation and therefore a significant reduction of its lifetime.

In some cases, bases are added during the curing step. See, for example, S. Das, S. Roy, A. Patra, P. K. Biswas, Materials Letters 2003, 57, 2320-2325 or F. Bauer, U. Decker, A. Dierdorf, H. Ernst, R. Heller, H. Liebe, R. Mehnert, Progress in Organic Coatings 2005, 53, 183-190. The bases need to be gaseous at the temperature of curing and are typically purged into the curing oven. This requires the use of expensive corrosion-resistant equipment and is inconvenient for large-scale processes.

It has now been found that sol-gel coatings or ceramics can be prepared which can be cured at much lower temperatures when the sol-gel process is carried out in the presence of a particular catalyst. Surprisingly, the process of the present invention avoids one or more of the disadvantages of prior-art processes.

Accordingly, the present invention relates to a sol-gel process for preparing a mixture of metal-oxide-metal compounds wherein at least one metal oxide precursor is subjected to a hydrolysis treatment to obtain one or more corresponding metal oxide hydroxides, the metal oxide hydroxides so obtained are subjected to a condensation treatment to form the metal-oxide-metal compounds, which process is carried out in the presence of a catalyst which comprises a labile protecting group (P_{g}) and a base (B) which are covalently linked, whereby the covalent link between the protecting group and the base is cleavable by exposure to an external stimulus, and wherein the base released after exposure to the external stimulus is capable of catalyzing the condensation of the metal-hydroxide groups that are present in the metal oxide hydroxides so obtained.

The sol-gel process in accordance with the present invention enables the preparation of sol-gel coatings or ceramics which can be cured at much lower temperatures while having acceptable mechanical properties. The process of the present invention allows the catalyst to be added to the formulation without changing the ratio of hydrolysis and condensation. Hence, the bath stability is largely unaffected.

The catalyst is primarily only active after being exposed to a defined external stimulus. The present process may allow for the inclusion of organic materials in the sol-gel such as hydrophobising agents or particular dyes to colour the substrate or article to be coated with the sol-gel, or to provide the sol-gel to be obtained with desired surface functionalities.

In the process in accordance with the present invention use is made of at least one metal oxide precursor, which means that use can be made of one type of metal oxide precursor or a mixture of two or more types of different metal oxide precursors.

Preferably, use is made of one type of metal oxide precursor.

The metal to be used in the metal oxide precursor can suitably be selected from magnesium, calcium, strontium, barium, borium, aluminium, gallium, indium, thallium, silicon, germanium, tin, antimony, bismuth, lanthanoids, actinoids, scandium, yttrium, titanium, zirconium, hafnium, vanadium, niobium, tantalum, chromium, molybdenum, tungsten, manganese, rhenium, iron, ruthenium, cobalt, nickel, copper, zinc and cadmium, and combinations thereof.

Preferably, the metal to be used is silicon, titanium, aluminium, zirconium and combinations thereof.

More preferably, the metal is silicon, titanium, aluminium and combinations thereof.

Suitably, the metal oxide precursor contains at least one hydrolysable group.

Preferably, the metal oxide precursor has the general formula R₁R₂R₃R₄M, wherein M represents the metal, and R₁₋₄ are independently selected from an alkyl, aryl, alkoxy, aryloxy, alkylthio, arylthio, halogen, nitro, alkylamino, arylamino, silylamino or silyloxy group.

The catalyst to be used in the present invention comprises a labile protecting group (P_{g}) and a base (B) which are covalently linked.

Preferably, the labile protecting group (P_{g}) is selected from carbobenzyloxy (Cbz), tert-butyloxycarbonyl (BOC), 9-fluorenylmethyloxycarbonyl (Fmoc), benzyl (Bn), p-methoxyphenyl (PMP), (α,α-dimethyl-3,5-dimethoxybenzyloxy)carbonyl (Ddz), (α,α-dimethyl-benzyloxy)carbonyl, phenyloxycarbonyl, p-nitrophenyloxycarbonyl, alkylboranes, alkylaryl boranes, arylboranes and mixtures thereof.

More preferably, the labile protecting group is (α,α-dimethyl-3,5-dimethoxybenzyloxy)carbonyl (Ddz) or phenyloxycarbonyl.

Most preferably, the labile protecting group is (α,α-dimethyl-3,5-dimethoxybenzyloxy)carbonyl (Ddz).

The base (B) to be used in the catalyst can suitably be selected from primary, secondary or tertiary aryl- or alkylamino compounds, aryl or alkyl phosphino compounds, alkyl- or arylarsino compounds or any other suitable other compound.

Preferably, the base is an amine or phosphine, or combinations thereof.

More preferably, the base is an amine. Examples of suitable amines to be used in accordance with the present invention include primary aliphatic and aromatic amines like aniline, naphthyl amine and cyclohexyl amine, secondary aliphatic, aromatic amines or mixed amines like diphenyl amine, diethylamine and phenethyl amine and tertiary aliphatic, aromatic amines or mixed amines like triphenyl amine, triethyl amine and phenyl diethylamine and combinations thereof.

Preferably, the amine is a primary or secondary amine.

Most preferably, the amine is an aromatic primary amine.

In accordance with the present invention, the catalyst to be used is preferably a carbamate. Carbamates contain the functional group —NH(CO)O—. The —HN—C— bond is highly labile. Preferably the catalyst is a carbamate where the protecting group (P_{g}) is covalently linked to the base (B).

The mixture of metal-oxide metal compounds (sol-gel) obtained in accordance with the present invention can suitably be subjected to a cleaving treatment during which the covalent link between the protecting group (P_{g}) and the base (B) of the catalyst is cleaved by exposure to an external stimulus, and wherein the base thus released catalyzes the condensation of the metal-hydroxide groups that are present in the metal-oxide-metal compounds.

One major advantage of the sol-gel process of the present invention is that it enables the subsequent curing treatments to be carried out at lower temperatures. Additional advantages include the possibility to include organic materials in the sol-gel such as particular dyes to colour the substrate or article to be coated with the sol-gel, or to provide the coating to be obtained with desired surface functionalities. Examples of suitable surface functionalities include hydrophobicity and hydrophilicity. The hydrophobic functionality can, for instance, be established by means of addition of fluoroalkyl compounds. The hydrophilic functionality can be established, for instance, by means of addition of hydrophilic polymers, e.g. poly(ethylene glycol).

The cleaving treatment can be carried out directly after the hydrolysis and condensation treatments. In a particular embodiment, however, the mixture of metal-oxide metal compounds is recovered after the condensation treatment. The sol-gel coating or ceramic object so obtained can then subsequently be subjected to the cleaving treatment.

An external stimulus is required to cleave the bond between the protecting group (P_{g}) and the base (B) thereby activating the catalyst. Examples of such stimuli are a heat stimulus, ultra-violet irradiation, microwave irradiation, electron beaming, laser treatment, chemical treatment, X-ray irradiation, gamma irradiation, and combinations thereof.

Preferably, the external stimulus is selected from heat stimulus and/or ultra-violet irradiation.

Most preferably, the external stimulus is a heat stimulus.

The curing treatment can suitably be carried out at a temperature in the range of 0° C. to 450° C., preferably in the range of from 100 to 300° C., more preferably in the range of from 125 to 250° C.

Suitably, the steps preceding the curing treatment (i.e. the hydrolysis and condensation) are carried out at conditions that do not cause activation of the catalyst.

In a specific embodiment, the cleaving treatment is initiated by a heat stimulus during the curing treatment.

The present invention further relates to processes for preparing a sol-gel ceramic, using the sol-gel process according to the present invention. Furthermore, the present invention relates to processes for preparing a coating and coating an object, using the sol-gel process according to the present invention, wherein a coating of the mixture of metal-oxide compounds as obtained in the present sol-gel process is applied on the substrate or the article and subsequently the coating so obtained is subjected to the cleaving and curing treatment.

Hence, the present invention also relates to a substrate obtainable by the present process for coating a substrate. In addition, the present invention also relates to an article obtainable by a present process for coating an article.

### EXAMPLES

### Example 1

### Evaluation of Ddz-Ph Catalyst for Inorganic Siloxane Coating Using a Thermal Stimulus for Activation of the Catalyst

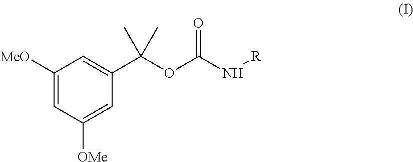

Formula I: Ddz-Ph Catalyst (R=Ph); cleaving temperature=164° C.

Pre-oligomerized tetraethoxysilane (POT)* in 2-propanol (104.2 g, solid content=4.8%) was diluted with 2-propanol (145.8 g) to a solid content of 2%. Then, Ddz-Ph catalyst was added in various steps (per step 50 mg, 1% based on solids). Test samples were prepared by dip-coating glass substrates (8×10 cm² samples; Guardian Float Glass-Extra Clear Plus) from the resulting mixture with different amounts of catalyst. The samples were cured in a humid environment using following temperature program: 100° C. (0.5 h) then 150° C. (0.5 h) then 250° C. (3 h). *synthesis of POT: A stirred solution of tetraethyl orthosilicate (135.2 g) in 2-propanol (368.5 g) was treated with water (124 g) and acetic acid (13.8 g). Then, the resulting mixture was stirred for 24 hours at room temperature. After 24 h, the reaction mixture was diluted with 2-propanol (372.6 g) and acidified with nitric acid (2.90 g) to obtain POT.

The scratch resistance of these coatings was determined using an Erichsen Hardness Test Pencil Model 318 supplied by Leuvenberg Test Techniek (Amsterdam). The results are shown in Table 1 below.

TABLE 1

| | Catalyst | Force |
|---|---|---|
| Entry | [%] | [N] |
| 1 | 0 | <0.1 |
| 2 | 1 | <0.1 |
| 3 | 2 | 0.7 |
| 4 | 3 | 0.6 |
| 5 | 4 | 0.3 |
| 6 | 5 | 0.2 |

Conclusion: For this inorganic test system, the optimum amount of catalyst to be added is 2% based on the solid weight in the formulation. The increase in hardness upon use of catalyst is at least a factor 7 as compared to the system without catalyst.

### Example 2

### Evaluation of Ddz-Ph Catalyst for Hybrid Siloxane Coating Using a Thermal Stimulus for Activation of the Catalyst

Methyltrimethoxysilane (MTMS) (1.64 g) was added dropwise to POT (100 g) of a concentration of 4.8%. The resulting formulation was stirred for 15 minutes and subsequently diluted with 2-propanol (150 g) to an end concentration of 2% silica from POT. Ddz-Ph catalyst (100 mg, 2%) was added to this mixture. Test samples were prepared by dip-coating glass substrates (8×10 cm² samples; Guardian Float Glass-Extra Clear Plus) from the mixtures containing 0% and 2% catalyst, respectively. The samples were cured in a humid environment using following temperature program: 100° C. (0.5 h) then 150° C. (0.5 h) then 250° C. (3 h). The scratch resistance of these coatings was determined using an Erichsen Hardness Test Pencil Model 318 supplied by Leuvenberg Test Techniek (Amsterdam). The results are shown in Table 2 below.

TABLE 2

| | Catalyst | Force |
|---|---|---|
| Entry | [%] | [N] |
| 1 | 0 | 0.7 |
| 2 | 2 | 1.4 |

Conclusion: For this hybrid test system, the increase in hardness upon use of catalyst is a factor 2.

### Example 3

### Evaluation of an Ultra-Violet Irradiation Stimulus for Activation of the Ddz-Ph Catalyst

The Ddz-Ph catalyst (25 mg) was dissolved in dry tetrahydrofurane (10 ml) and irradiated for 10 hours at room temperature by using a 450 W medium pressure mercury lamp. The resulting solution composition was analysed by GC-MS. The presence of aniline as photo-decomposition product was revealed by co-injection of the base itself.

Conclusion: The Ddz-Ph catalyst can be activated by an ultra-violet irradiation stimulus.

### Example 4

### Evaluation of pH-TDI Catalyst for Inorganic Siloxane Coating Using a Thermal Stimulus for Activation of the Catalyst

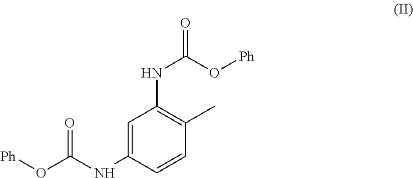

Formula II: Ph-TDI catalyst; cleaving temperature=130° C.

Ph-TDI catalyst was evaluated in the POT system, as described in Example 1. Since the catalyst was poorly soluble in 2-propanol, toluene was added to guarantee the complete solubility of the catalyst. Then, plates were dipped with 0 and 2% catalyst. The scratch resistance results of these coatings are shown in Table 3 below.

TABLE 3

| | Catalyst | Force |
|---|---|---|
| Entry | [%] | [N] |
| 1 | 0 | 1 |
| 2 | 2 | 7 |

Conclusion: For this inorganic test system, the use of 2% Ph-TDI catalyst results in an increase in hardness of a factor 7 as compared to the system without catalyst.

### Example 5

### Evaluation of Ddz-Ph Catalyst for Inorganic Titania Coating Using a Thermal Stimulus for Activation of the Catalyst

Titanium-isopropoxide (12.0 g) was slowly treated with glacial acetic acid (2.5 g) at room temperature. Then, the mixture was diluted with 2-propanol (240 g). Ddz-Ph catalyst (2%) was added to this mixture. Test samples were prepared by dip-coating glass substrates (8×10 cm² samples; Guardian Float Glass-Extra Clear Plus) from the mixtures containing 0% and 2% catalyst, respectively. The samples were cured in a humid environment using following temperature program: 100° C. (0.5 h) then 150° C. (0.5 h) then 250° C. (3 h). The scratch resistance of these coatings was determined using an Erichsen Hardness Test Pencil Model 318 supplied by Leuvenberg Test Techniek (Amsterdam). The results are shown in Table 4 below.

TABLE 4

| | Catalyst | Force |
|---|---|---|
| Entry | [%] | [N] |
| 1 | 0 | 0.5 |
| 2 | 2 | 1 |

Conclusion: For this inorganic test system, addition of catalyst leads to an increase of hardness by a factor 2 as compared to the system without catalyst.

### Example 6

### Comparison Thermal Cure

### Catalytic Cure

Component I: Tetraethoxysilane (17.11 g) was dissolved in 2-propanol (15.52 g) and cooled to 0° C. Then, 0.1 M aqueous p-toluenesulfonic acid (1.76 g) was added. After 0.5 h of stirring at 0° C., a second portion of aqueous p-toluenesulfonic acid (1.76 g) was added. The resulting mixture was stirred for 1 h at 0° C.

Component II: Ethylacetonate (1.98 g) was dissolved in 2-propanol (1.24 g) and treated with aluminium-sec-butoxide (3.72 g) at 0° C. The resulting mixture was stirred for 30 min at 0° C.

Component II is added to component I at 0° C. and treated with aqueous p-toluenesulfonic acid (2.36 g). The resulting mixture is stirred for 30 min at 0° C. and subsequently pored into 2-propanol (136.4 g) at room temperature under vigorous stirring.

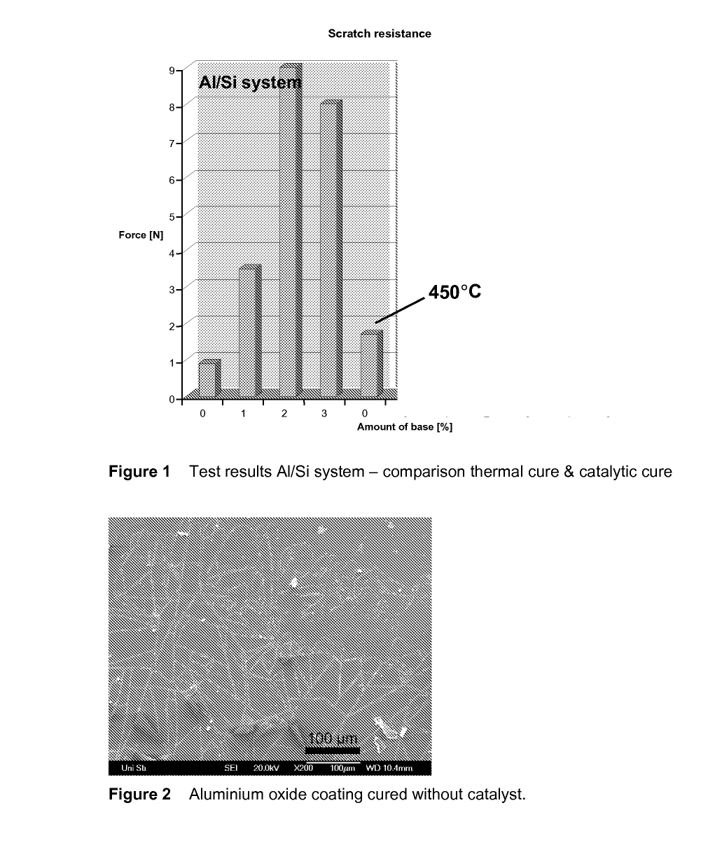

Ddz-Ph catalyst was added and the resulting mixture was applied to glass substrate by dip-coating. The samples were cured in a humid environment using following temperature program: 100° C. (0.5 h) then 150° C. (0.5 h) then 250° C. (3 h) or 450° C. (4 h). The scratch resistance of these coatings was determined using an Erichsen Hardness Test Pencil Model 318 supplied by Leuvenberg Test Techniek (Amsterdam). The scratch resistance results are shown in FIG. 1 which shows the test results for an Al/Si system, a comparison between thermal cure and catalytic cure.

Conclusion: For this inorganic test system, the mechanical strength obtained with catalytic curing at 250° C. is higher than the mechanical strength obtained with thermal curing 450° C.

### Example 7

### Modelling Experiment for Use of Ddz-Ph Catalyst in Aluminiumoxide Ceramics Using a Thermal Stimulus for Activation of the Catalyst

Ethylacetonate (1.98 g) was dissolved in 2-propanol (1.24 g) and treated with aluminium-sec-butoxide (3.72 g) at 0° C. The resulting mixture was stirred for 30 min at 0° C. 2% of catalyst were added based on the weight solids (FIG. 2 and FIG. 3 show the aluminium oxide coating cured without and with catalyst respectively). The samples were cured in a humid environment using following temperature program: 100° C. (0.5 h) then 150° C. (0.5 h) then 250° C. (3 h).

Conclusion: Without catalyst, the aluminium oxide coating shows cracks after curing. In contrast, the coating with catalyst shows no signs of crack formation.

### Example 8

### Influence of Catalyst on Aluminium Oxide Ceramic System

Preparation of α-aluminium oxide pellet: Two pellets were prepared from a submicron powder produced in an Aluminium-Alum process. The pellets were pressed for 5 minutes with a pressure of 30 kN. The density of the resulting pellets was 1.67 g·cm⁻³.

One pellet was immersed over night in the solution as described in example 5. Both pellets were cured in a humid environment using following temperature program: 100° C. (0.5 h) then 150° C. (0.5 h) then 250° C. (3 h). Then, the pellets were sintered in air for 1 hour at 1350° C.

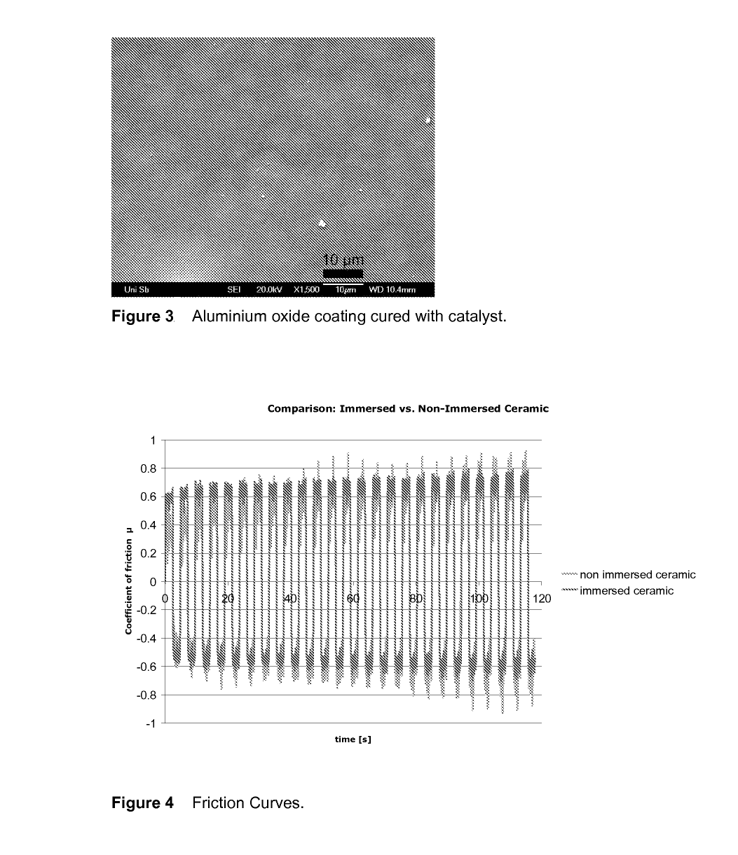

Friction measurements were performed on both samples. The non-immersed sample showed a steep increase and a relatively large fluctuation (see the friction curves comparing immersed and non-immersed ceramics in FIG. 4). In contrast, the immersed sample showed a much higher homogeneity. This is in agreement with the results of the model system, as described in Example 6.

Conclusion: The friction behaviour is different for samples immersed with catalyst. This can be explained by the results obtained with the aluminium oxide model system, as described in Example 5.

1. A sol-gel process for preparing a mixture of metal-oxide-metal compounds wherein at least one metal oxide precursor is subjected to a hydrolysis treatment to obtain one or more corresponding metal oxide hydroxides, the metal oxide hydroxides so obtained are subjected to a condensation treatment to form the metal-oxide-metal compounds, which process is carried out in the presence of a catalyst which comprises a labile protecting group (P_{g}) and a base (B) which are covalently linked, whereby the covalent link between the protecting group and the base is cleavable by exposure to an external stimulus, and wherein the base released after exposure to such external stimulus is capable of catalyzing the condensation of the metal-hydroxide groups that are present in the metal oxide hydroxides so obtained.

2. The process according to claim 1, wherein the metal is selected from the group consisting of magnesium, calcium, strontium, barium, borium, aluminium, gallium, indium, thallium, silicon, germanium, tin, antimony, bismuth, lanthanoids actinoids, scandium, yttrium, titanium, zirconium, hafnium, vanadium, niobium, tantalum, chromium, molybdenum, tungsten, manganese, rhenium, iron, ruthenium, cobalt, nickel, copper, zinc, and cadmium.

3. The process according to claim 2, wherein the metal is silicon, titanium, aluminium, zirconium or a mixture thereof.

4. The process according to claim 1, wherein the metal oxide precursor has the general formula R₁R₂R₃R₄M, wherein M represents the metal, and R₁₋₄ are independently selected from alkyl, aryl, alkoxy, aryloxy, alkylthio, arylthio, halogen, nitro, alkylamino, arylamino, silylamino or silyloxy group.

5. The process according to claim 1, wherein the labile protecting group (P_{g}) is selected from carbobenzyloxy (Cbz), tert-butyloxycarbonyl (BOC), 9-fluorenylmethyloxycarbonyl (Fmoc), benzyl (Bn), p-methoxyphenyl (PMP), (α,α-dimethyl-3,5-dimethoxybenzyloxy)carbonyl (Ddz), (α,α-dimethylbenzyloxy)carbonyl, phenyloxycarbonyl, p-nitrophenyloxycarbonyl, alkylboranes, alkylaryl boranes, arylboranes and mixtures thereof.

6. The process according to claim 1, wherein the base (B) is selected from the group consisting of primary, secondary or tertiary aryl- or alkylamino compounds, aryl or alkyl phosphino compounds, alkyl- or arylarsino compounds.

7. The process according to claim 1, wherein the base is an amine or phosphine.

8. The process according to claim 1, wherein the base is an amine.

9. The process according to claim 1, wherein the catalyst comprises a carbamate.

10. The process according to claim 1, wherein the covalent link between the protecting group and the base is cleavable by exposure to heat stimulus, ultra-violet irradiation, microwave irradiation, electron beaming, laser treatment, chemical treatment, X-ray irradiation and gamma irradiation, or any suitable combination thereof.

11. The process according to claim 1, wherein covalent link between the protecting group and the base is cleavable by exposure to heat stimulus and/or ultra-violet irradiation.

12. A process for coating a substrate or an article wherein a coating of the mixture of metal-oxide compounds as obtained in claim 1, is applied on the substrate or the article and subsequently the coating so obtained is subjected to the curing treatment.

13. A substrate or article obtainable by a process according to claim 12.

14. A process for preparing a ceramic object wherein a mixture of metal-oxide compounds as obtained in claim 1, is used to prepare a ceramic object and subsequently the object so obtained is subjected to the curing treatment.

15. A substrate or article obtainable by a process according to claim 14.
